(19) United States
(12) Patent Application Publication
(10) Pub. No.: US 2024/0126681 A1
(43) Pub. Date: Apr. 18, 2024

(54) Method and system for dynamically detecting memory sub-channel mapping and data lane mapping between a memory controller and physical layer circuitry

(71) Applicant: Intel Corporation, Santa Clara, CA (US)

(72) Inventors: Zhiguo WEI, Shanghai (CN); Yufu LI, Shanghai (CN); Tao XU, Shanghai (CN)

(21) Appl. No.: 18/539,350

(22) Filed: Dec. 14, 2023

(30) Foreign Application Priority Data
May 25, 2023 (WO) PCT/CN2023/096227

(51) Int. Cl. G06F 12/02

(52) U.S. Cl. CPC G06F 12/0223

(57) ABSTRACT

A method and apparatus for detecting data lane mapping between a first circuitry and a second circuitry in a system. The first and second circuitry include a plurality of first and second data lanes, respectively that are mapped each other. The external device and the first circuitry are configured with a specific data pattern. A data transfer test is performed such that the specific data pattern is transferred from the external device to the first circuitry via the second data lanes. The data transfer test is performed iteratively by adjusting timing parameters for the second data lanes in the second circuitry in a pre-configured range while setting a timing parameter for a target second data lane in the second circuitry to an invalid value. Data lane mapping for the target second data lane between the first circuitry and the second circuitry is determined based on the data transfer test result.

### BACKGROUND

Semiconductor intellectual property block (IP block) is a reusable unit of integrated circuit that is the intellectual property of one party. IP blocks can be licensed to another party to be integrated into a silicon package. Designers of systems of field-programmable gate array (FPGA) and system on chip (SoC) can use IP blocks as building blocks.

### BRIEF DESCRIPTION OF THE FIGURES

Some examples of apparatuses and/or methods will be described in the following by way of example only, and with reference to the accompanying figures, in which:

FIG. 1 shows the basic blocks of a memory sub-system;

FIG. 2 shows sub-channel swizzling between a memory controller and a Double Data Rate 5 (DDR5) physical layer (PHY) circuitry;

FIG. 3 shows a lane connection between a memory controller and a DDR5 PHY circuitry;

FIG. 4 shows a data queue (DQ) lane data transfer test;

FIG. 5 shows an example basic input output service (BIOS) memory reference code (MRC) flow to obtain a receive (Rx) phase locked loop (PLL) delay margin;

FIG. 6 shows an example data transfer result of each DQ lane viewed from a memory controller training engine side when sweeping Rx PLL delay of a sub-channel;

FIG. 7 is a block diagram of a system configured for detecting data lane mapping between a first circuitry and a second circuitry;

FIG. 8 shows a PCIe ×4 connection to which the examples can be applied;

FIG. 9 is a flow diagram of an example method for detecting data lane mapping between a first circuitry and a second circuitry in a system;

FIG. 10 shows an example flow of detecting sub-channel (re)mapping;

FIG. 11 shows an example zero margin reported on memory controller sub-channel A;

FIG. 12 shows a DQ lane mapping example in a DDR5 sub-channel;

FIG. 13 shows an example BIOS MRC flow for detecting DQ lane mapping between a memory controller and a DDR5 PHY circuitry;

FIG. 14 shows a zero margin reported on DQ5 of a memory controller;

FIG. 15 is a block diagram of an electronic apparatus incorporating at least one electronic assembly and/or method described herein;

FIG. 16 illustrates a computing device in accordance with one implementation of the invention; and

FIG. 17 is included to show an example of a higher-level device application for the disclosed embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

Hereafter, examples will be explained with reference to a memory system supporting Double Data Rate 5 (DDR5) memory specification. However, it should be noted that the examples are applicable to any memory specification that are currently existing or will be developed in the future.

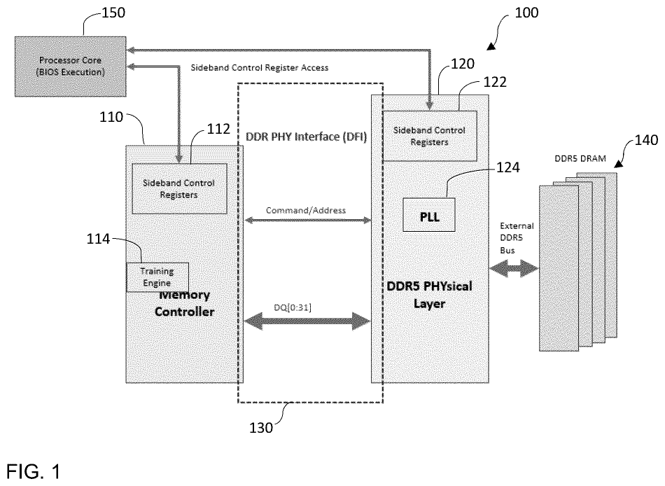

FIG. 1 shows an example system in which the examples disclosed herein may be implemented. The memory system 100 may include different circuit blocks, such as a memory controller 110, a physical layer (PHY) circuitry 120 (e.g., DDR5 PHY circuitry), etc. The memory system 100 and the processor core 150 may be integrated into a single chip (e.g., an SoC package) or may be included in separate chips. The memory controller 110 and the PHY circuitry 120 are connected to each other by internal high speed in-band buses 130. The PHY circuitry 120 is connected to external dynamic random-access memory (DRAM) devices 140 by an external bus (e.g., a JEDEC DDR5 bus). The memory controller 110 and the PHY circuitry 120 include sideband control registers 112, 122, respectively, and are controlled by Basic Input Output System (BIOS) memory reference codes (MRC) through the respective sideband control registers 112, 122. The BIOS MRC running on the processor (e.g., a processor core) 150 controls the memory controller 110 through the sideband control registers 112 and controls the PHY circuitry 120 through the sideband control registers 122.

The memory controller 110 is the primary circuit block that communicates with the PHY circuitry 120 over the internal bus 130, such as Scalable PHY Interface for DDR (SPID) or DDR PHY Interface (DFI). During a training mode, the memory controller 110 accepts memory transaction requests from its memory training engine 114, schedules them appropriately, and sends them to the PHY circuitry 120. During a normal mode, the memory controller 110 accepts memory transaction requests from the processor core 150, schedules them appropriately, and sends them to the PHY circuitry 120.

Modern memory systems use synchronous communication to achieve high data transmission rates to and from the memory module (e.g., a dynamic random-access memory (DRAM) module). The memory system communicates synchronously using a clock signal as a timing reference so that data can be transmitted and received with a known relationship to the timing reference. Phase-locked loops (PLLs) 124 or delay-locked loops (DLLs) (hereafter collectively PLLs) in the PHY circuitry 120 are used to maintain a fixed timing relationship between the clock and data signals. The PLLs 124 work by continuously comparing the relationship between the two signals and providing feedback to adjust and maintain the fixed timing relationship between them.

The PHY circuitry 120 translates the digital requests from the memory controller 110 sent over the internal bus 130 (e.g., SPID or DFI interface) into a signaling voltage that matches the memory specification (e.g., DDR5 specification). A read or write request transfers data between the PHY circuitry 120 and the target memory (the DRAM 140) over data queue (DQ) lanes. The PLL delays of the DQ lanes are controlled by the per-lane sideband control registers (CR) in the PHY circuitry 120. A DQ lane can only transfer data correctly when its PLL delay is set properly.

Even though the memory controller 110 and the PHY circuitry 120 (e.g., in an SoC) have pre-defined external DQ interfaces, the DQ lane connection between the memory controller 110 and the PHY circuitry 120 are flexible and are variable for different SoCs, depending on the specific SoC integration.

The data width of the DDR5 memory system is 64-bit. DDR5 splits the data width into two independent 32-bit sub-channels to increase efficiency and lower the latencies for data accesses for the memory controller. Eight bits are added to each sub-channel for error correction control (ECC) support for a total of 40 bits per sub-channel. Two sub-channels in a DDR5 channel exist both in a memory controller and a DDR5 PHY circuitry.

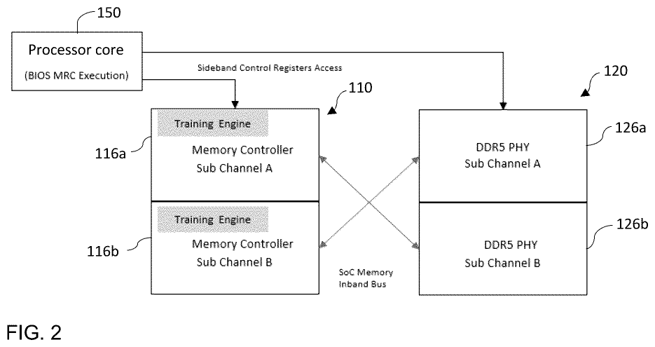

The data lane (DQ lane) connection between the memory controller 110 and the PHY circuitry 120 is flexible and depends on SoC design and an operating mode. FIG. 2 shows an example of sub-channel swizzling between a memory controller 110 and a DDR5 PHY circuitry 120. It is possible that memory controller sub-channel A 116a links to DDR5 PHY sub-channel B 126b and memory controller sub-channel B 116b links to DDR5 PHY sub-channel A 126a, as shown in FIG. 2, or memory controller sub-channel A 116a links to DDR5 PHY sub-channel A 126a and memory controller sub-channel B 116a links to DDR5 PHY sub-channel B 126b.

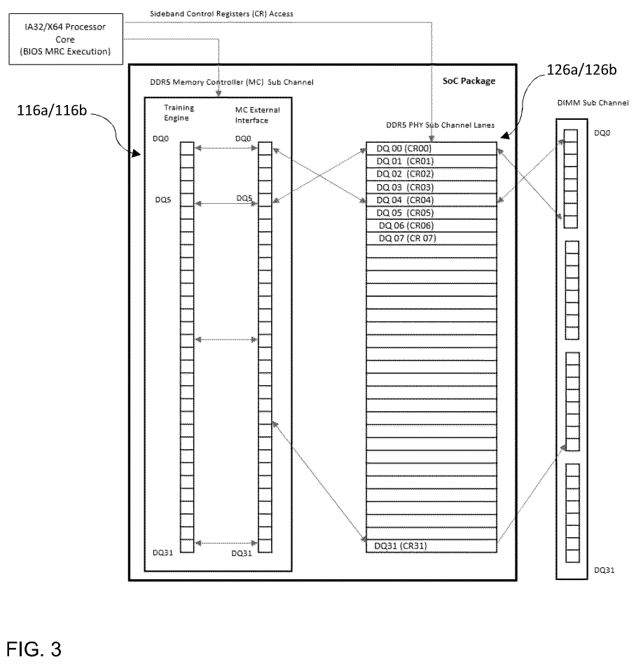

The data lane (DQ lane) connection within a sub-channel is also flexible. The swizzling is allowed within a sub-channel as well. FIG. 3 shows an example of DQ lane connection between a memory controller 110 and a PHY circuitry 120 within a sub-channel. As an example, FIG. 3 shows that DQO of the memory controller sub-channel 116a/116b connects to DQ4 of DDR5 PHY sub-channel 126a/126b and DQ5 of the memory controller sub-channel 116a/116b connects to DQO of the DDR5 PHY sub-channel 126a/126b.

The lane mapping is very complex, because there are 40 DQ lanes per DDR5 sub-channel. To operate correctly by BIOS, an SoC designer maintains and releases this complex sub-channel mapping and DQ lane mapping table and releases it to a BIOS team, and this table will be used for the whole life cycle. As different SOC design could have different swizzling, there may be quite a few DQ mappings for one generation program.

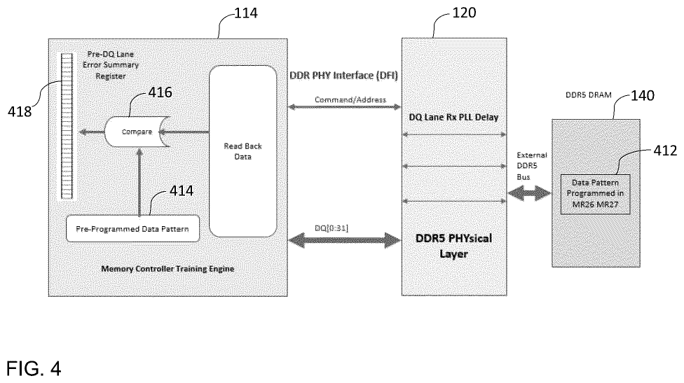

FIG. 4 illustrates an example DDR5 DQ lane data transfer test for a DQ Rx PLL delay point. This process is also called DQ Rx PLL delay point test. The DQ lane data transfer test may be implemented by MRC executed on a processor/processor core 150. MRC is responsible for initializing the memory as part of the power-on self-test (POST) process at power-on. MRC is a part of BIOS (or firmware) of the motherboard. MRC determines how the computer's memory will be initialized and adjusts memory timing algorithm correctly. MRC uses a memory training engine 114, such as Converged Pattern Generator and Checker (CPGC) or Memory Training Engine (MTE), to test memory data transfer on DQ lanes under current DQ Rx PLL delay.

First, the MRC configures a DRAM 140 so that the DRAM 140 can send out a specific data pattern 412 to a memory controller 110 when the DRAM 140 receives a read command from the memory controller 110. The specific data pattern 412 may be programmed into the memory registers MR26 and MR27 in the DRAM 140. Secondly, at memory host controller side, the MRC configures the memory training engine 114 with the same data pattern. Then, the training engine 114 sends out a read command to the DRAM 140 to read the pre-programmed data pattern 412 from the DRAM 140 and compares 416 the received data pattern with the same pre-programmed data pattern 414 stored in the training engine 114. The comparison result of each DQ lane is reported by the per-DQ lane error summary register 418 in the training engine 114. If the corresponding bit on the per-DQ lane error summary register 418 reports no error, it means that the DDR5 PHY Rx PLL delay of that DQ lane is set with a valid value. If the corresponding bit on the per-DQ lane error summary register 418 reports an error, it means that the Rx PLL delay of that DQ lane is set with an invalid value.

When a DDR memory controller and a DDR PHY circuitry are integrated into an SoC, the DQ lane connections between the memory controller 110 and the PHY circuitry 120 may be flexible and variable, depending on different SoC design and operation modes. Currently BIOS MRC designers must depend on SoC designers to provide the static sub-channel mapping and DQ lane mapping table and translate this table into BIOS MRC code. This introduces cross team or cross company design dependency and complexity. Static mapping table can only support limited number of vendors and it is integrated into memory controller firmware at build time. It cannot support a new IP vendor without re-designing/re-building BIOS. The static mapping table requires co-working between different IP vendors/IP teams. Any new IP change requires each team to work together again to re-define and update the static table, re-integrate it to BIOS, and to re-validate BIOS. It also requires BIOS re-building and new BIOS image release to a customer. This will impact the project development cycle and schedule seriously.

Examples disclosed herein provide solutions for dynamically detecting the data lane (e.g., DDR5 DQ lane) mapping and/or a sub-channel mapping between a memory controller 110 and a PHY circuitry 120 of the memory system. In some examples, the MRC may leverage the per-DQ lane Rx PLL delay margin test to determine the DQ lane mapping and/or the sub-channel mapping between the memory controller 110 and the PHY circuitry 120. This solution can be extended to other circuitry connection other than the memory sub-system.

The examples disclosed herein provide numerous advantages. The examples support new DDR PHY and memory vendors dynamically without re-defining the fixed mapping table, re-building, re-validating, and releasing a new BIOS image to customers. The examples accelerate project development cycle and product launch. With this scheme, the complex DQ lane mapping logic is no longer needed to be maintained by the SOC designer and the overall BIOS enabling logic and debug effort will be reduced dramatically.

The examples save the design effort and reduce the complexity of SoC development. SoC designers do not have to maintain and release the DQ lane mapping table for each SoC platform, and do not need to deliver the static mapping table to other companies or teams. The examples remove the MRC dependency on specific SoC design in terms of DQ lane mapping. The examples save the design effort and reduce the complexity of MRC development. BIOS developers do not need to manually translate the lane mapping table for each SoC platform. The automatic lane mapping detection in accordance with the examples disclosed herein replaces the manual lane mapping checking, which improves the MRC software quality. In examples disclosed herein, the pre-defined DQ lane mapping table in MRC code may not be used, but the per-DQ lane Rx PLL delay margin test algorithm is leveraged to detect the sub-channel mapping and the DQ lane mapping between a memory controller and a PHY circuitry automatically (e.g., during boot time).

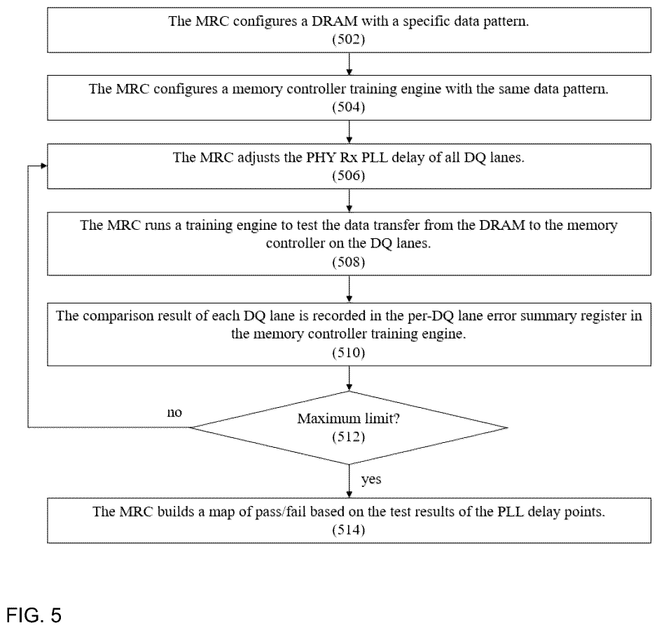

FIG. 5 shows a flow for the per-DQ lane Rx PLL delay margin test (simply referred to as “delay margin test”) to obtain a PLL delay margin for DQ lanes. During the per-DQ lane Rx PLL delay margin test, the MRC (which may be a part of BIOS or other firmware) adjusts/sweeps the per-DQ lane Rx PLL delay in order to determine the Rx PLL delay margin (simply “delay margin”) for the DQ lanes. The MRC configures a DRAM with a specific data pattern (502). The MRC configures a DRAM mode register (e.g., mode register 26 and 27 (MR26, MR27)) with a specific data pattern so that the DRAM 140 can send out the specific data pattern to the memory controller 110 on each DQ lane when the DRAM 140 receives a read command from the memory controller 110.

The MRC also configures the memory controller training engine 114 with the same data pattern (504). The MRC configures the memory controller training engine 114 for data read from the DRAM 140 and comparison of the read data with the data pattern stored in the memory controller training engine 114.

The per-DQ lane Rx PLL delay margin test is then performed iteratively while sweeping the whole range of (DDR5) PHY per-DQ lane Rx PLL delay values. The MRC adjusts the PHY Rx PLL delay of all DQ lanes in a pre-configured range (506). For example, the MRC may initially set the PHY Rx PLL delay to a starting value (e.g., a minimum value) for all DQ lanes and adjust step-by-step for each iteration. For each DQ lane on the (DDR5) PHY circuitry, there is a sideband control register 122. The MRC configures the sideband control register 122 in the PHY circuitry 120 to set/adjust the Rx PLL delay for each DQ lane.

At each Rx PLL delay point, the MRC runs the training engine 114 to test the data transfer from the DRAM 140 to the memory controller 110 on the DQ lanes (508). The training engine 114 sends out a read command to the DRAM 140 to read the pre-programmed data pattern from the DRAM 140 and compares the received data pattern with the same pre-programmed data pattern stored in the training engine 114.

The comparison result (pass/fail result) of each DQ lane is recorded in the per-DQ lane error summary register 418 in the memory controller training engine 114 (510). A DQ lane can only transfer data correctly when the Rx PLL delay for the DQ lane is set in a valid range. If the data transfer is correct at that PLL delay point, the MRC records a “pass” for that DQ lane, and if the data transfer is not correct at that PLL delay point, the MRC records a “failure” for that DQ lane.

It is then determined whether the pre-defined PHY Rx PLL delay maximum limit is reached (512). If the pre-defined PHY Rx PLL delay maximum limit is not reached, the process goes back to step 506 for the next PHY Rx PLL delay. The MRC adjusts the PHY Rx PLL delay value step by step (e.g., from the pre-defined minimum limit to a pre-defined maximum limit) and iteratively performs the data transfer test at each PLL delay point. If it is determined that the pre-defined PHY Rx PLL delay maximum limit is reached (i.e., the PLL delay sweeping is done), the MRC builds a map of pass/fail based on the test results of the PLL delay points (514).

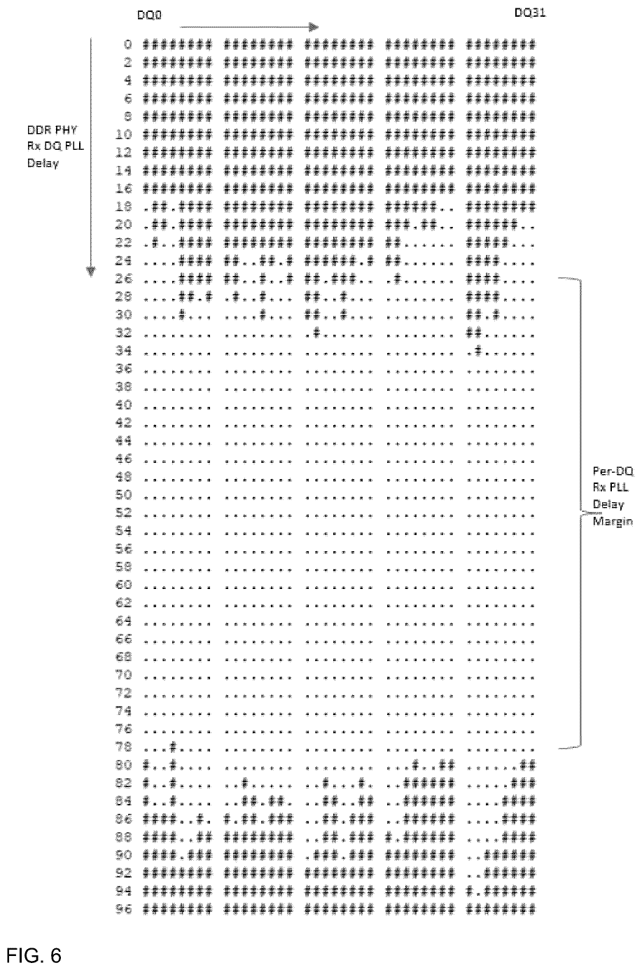

FIG. 6 shows an example data transfer pass/fail map. FIG. 6 shows an example test result (data transfer result) of each DQ lane viewed from a memory controller training engine side when sweeping the Rx PLL delay of a (DDR5) sub-channel. In FIG. 6, the x-axis is the DQ lane number (e.g., from DQO to DQ31) of a (DDR5) sub-channel of the memory controller, and the y-axis is the (DDR5) PHY Rx PLL delay (e.g., from 0 to 96) of the (DDR5) PHY circuitry. If the data transfer is correct at a PHY Rx PLL delay point, the MRC prints ‘ for that DQ lane, which represents a “pass,” and if the data transfer is not correct at a PLL delay point, the MRC prints’#′ for that DQ lane, which represents a “failure.” The length of the “dots” in the y-axis is called the PLL delay margin of that DQ lane. If there is no “dot” (no pass) for a DQ lane in the y-axis, it is called that this DQ lane has a zero delay margin.

Examples for detecting data lane mapping between a first circuitry and a second circuitry in a system will be explained hereafter.

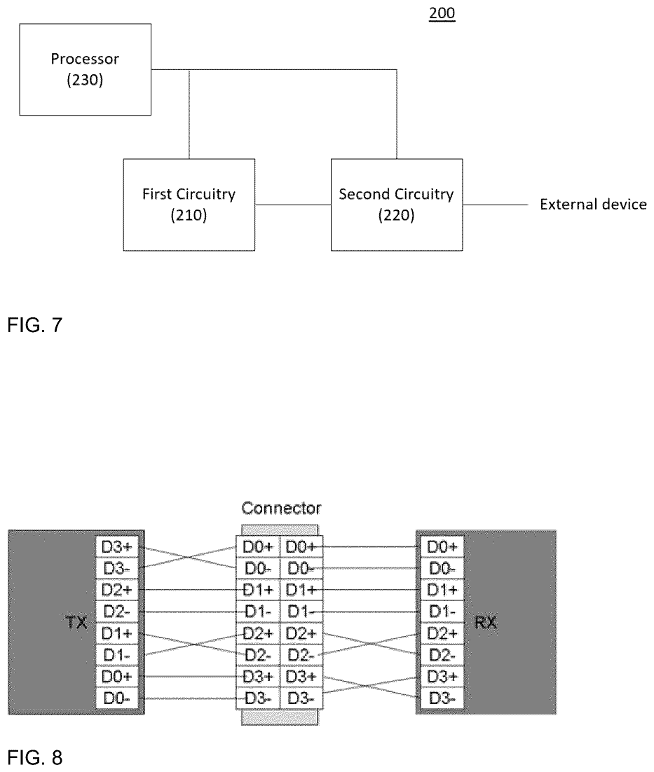

FIG. 7 is a block diagram of a system configured for detecting data lane mapping between a first circuitry and a second circuitry. The system 200 includes a first circuitry 210, a second circuitry 220, and a processor 230 (e.g., a processor core). The first circuitry 210 includes a plurality of first data lanes, and the second circuitry 220 includes a plurality of second data lanes for transferring data. Each of the first data lanes is mapped/coupled to a different one of the second data lanes. The first circuitry 210 and the second circuitry 220 are coupled via an (internal) bus so that data may be transferred between the first circuitry 210 and the second circuitry 220 via the mapped/coupled first and second data lanes. The second circuitry 220 is coupled to an external device via an external bus. The second circuitry 220 is configured to transfer data between the first circuitry 210 and the external device via the plurality of second data lanes.

The processor 230 (processing circuitry) is configured to execute software codes, e.g., BIOS, firmware, etc. The software code (e.g., which may be a part of BIOS) is adapted to, if executed on the processor 230, configure both the external device and the first circuitry 210 with a specific data pattern. The same specific data pattern is stored in the first circuitry 210 and the external device, respectively. The software code is also adapted to configure the second circuitry 220 for transfer of the specific data pattern from the external device to the first circuitry 210. The software code is configured to perform a data transfer test from the external device to the first circuitry 210. For example, the software code may run a training engine in the first circuitry 210 to perform a data transfer test. During the data transfer test, the specific data pattern stored in the external device is transferred from the external device to the first circuitry 210 via the second circuitry 220 and the training engine in the first circuitry 210 compares the received specific data pattern to the specific data pattern stored in the first circuitry 210. The specific data pattern is transferred to the first circuitry 210 via the mapped first and second data lanes in the first and second circuitries 210, 220. The data transfer on the second data lanes in the second circuitry 220 may be controlled by timing parameters. The timing parameters may control proper data transfer from the external device onto the second data lanes. The data lanes may transfer the data only if the timing parameters for the second data lanes are set to a proper/valid value. The timing parameters are controlled by the software code running on the processor 230.

In order to determine the data lane mapping between the first circuitry 210 and the second circuitry 220, the software code may be adapted to perform the data transfer test iteratively by adjusting the timing parameters for the second data lanes in the second circuitry 220 while setting a timing parameter for a target second data lane in the second circuitry 220 to an invalid value. The target second data lane whose timing parameter is set to an invalid value cannot properly transfer the data from the external device and therefore the data transfer test on that data lane (i.e., the comparison of the received data on that data lane to the stored data at the first circuitry 210) will fail at the first circuitry 210. The software code may be adapted to determine data lane mapping for the target second data lane between the first circuitry 210 and the second circuitry 220 based on results of the data transfer test.

The timing parameters for the second data lanes may be PLL (or DLL) delay values for the second data lanes in the second circuitry 220. Alternatively, the timing parameters may be any parameters that can control proper data transfer on the second data lanes. The second circuitry 220 may include control registers and the timing parameters (or any other parameters) for the second data lanes may be controlled by the software code using the control registers.

The first data lanes and the second data lanes may be divided into two or more sub-channels (e.g., two sub-channels). In some examples, the timing parameter of second data lanes of one sub-channel in the second circuitry 220 may be set to the invalid value while the timing parameters of second data lanes of other sub-channels are adjusted in a pre-configured range. By iteratively performing the data transfer test while adjusting the timing parameters of second data lanes of other sub-channels, a sub-channel mapping between the first circuitry 210 and the second circuitry 220 may be determined based on the results of the data transfer test. The determination of the data lane mapping between the first circuitry 210 and the second circuitry 220 may be performed during a boot up of the system 200.

In one example, the first circuitry 210 may be a memory controller of a memory sub-system, the second circuitry 220 may be a PHY circuitry of the memory sub-system, and the external device may be a memory module (e.g., a DRAM module). For example, the memory controller and the PHY circuitry may be compliant to DDR5 standards.

In some examples, the system 200 may be a system on chip (SoC). The SoC may include the processor 230, a memory controller as the first circuitry 210, and PHY circuitry as the second circuitry 220. The memory controller includes the plurality of first data lanes, and the PHY circuitry includes the plurality of second data lanes. Each first data lane in the memory controller is mapped to a different second data lane in the PHY circuitry.

The processor 230 may be configured to execute memory reference code (MRC). The MRC may be configured, if executed on the processor 230, to configure a memory module and the memory controller with a specific data pattern, configure the PHY circuitry for transfer of the specific data pattern from the memory module to the memory controller, perform a data transfer test, and determine data lane mapping for the target second data lane between the memory controller and the PHY circuitry based on results of the data transfer test. The specific data pattern stored in the memory module is transferred from the memory module to the memory controller via the plurality of second data lanes during the data transfer test. The MRC is configured to perform the data transfer test iteratively by adjusting timing parameters for the second data lanes in the PHY circuitry while setting a timing parameter for a target second data lane in the PHY circuitry to an invalid value.

For the data transfer test, a request may be sent from the memory controller to the memory module. In response to the request, the memory controller receives the specific data pattern sent from the memory module on the first data lanes. The memory controller then compares the specific data pattern received from the memory module to the specific data pattern stored in the memory controller. The memory controller then records a comparison result for each first data lane in a register.

In another example, the examples are applicable to Peripheral Component Interconnect Express (PCIe) connections. FIG. 8 shows an example PCIe ×4 connection with polarity and lane reversal. In this example, there is a lane reversal, and two of the four lanes (lane #0 and #2) have polarity inversion between the transmitter (Tx) and the receiver (Rx). The examples disclosed herein can be applied to the PCIe training for any PCIe connections (PCIe ×4, ×8, ×16, etc.) to detect this lane swizzling for system configuration.

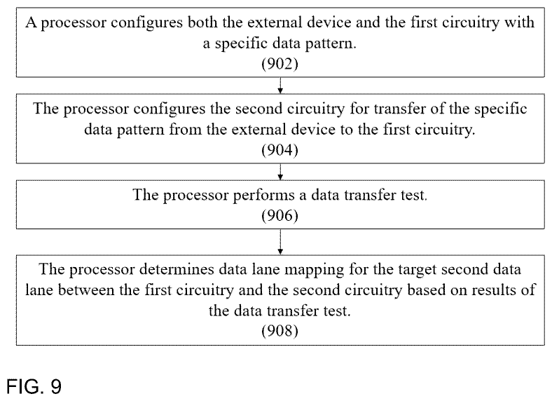

FIG. 9 is a flow diagram of an example method for detecting data lane mapping between a first circuitry and a second circuitry in a system. The processor 230 (i.e., a software code running on the processor 230) configures both the external device and the first circuitry 210 with a specific data pattern (902).

The processor 230 configures the second circuitry 220 for transfer of the specific data pattern from the external device to the first circuitry 210 (904). The processor 230 may adjust and set the timing parameters for the second data lanes to certain values to control the data transfer via the second data lanes.

The processor 230 performs a data transfer test (906). The specific data pattern stored in the external device is transferred from the external device to the first circuitry 210 via the plurality of second data lanes and then on the plurality of first data lanes during the data transfer test. The data transfer test may be performed iteratively by adjusting timing parameters for the second data lanes in the second circuitry 220 in a pre-configured range while setting a timing parameter for a target second data lane in the second circuitry 220 to an invalid value.

The processor 230 determines data lane mapping for the target second data lane between the first circuitry 210 and the second circuitry 220 based on results of the data transfer test (908).

Detailed examples for detecting the data lane mapping between a memory controller (first circuitry) and PHY circuitry (second circuitry) are explained hereafter. In examples, the MRC (or other firmware/software) running on a processor is modified to perform the above-described per-DQ lane Rx PLL delay margin test to dynamically detect data lane mapping and/or sub-channel mapping between the memory controller 110 and the PHY circuitry 120. In examples, the (BIOS) MRC may run the PLL delay margin test on both sub-channel A and sub-channel B from the memory controller side, while adjusting/sweeping the Rx PLL delay of one PHY sub-channel (e.g., PHY sub-channel A) in a pre-configured range and keeping the Rx PLL delay of the other PHY sub-channel (e.g., PHY sub-channel B) in an invalid value. Since the Rx PLL delay of one of the PHY sub-channels is kept invalid, this PHY sub-channel cannot correctly transfer data and will lead to a zero margin on the memory controller sub-channel coupled to that PHY sub-channel.

Memory controller sub-channel A may connect to PHY sub-channel A or PHY sub-channel B, and memory controller sub-channel B may connect to PHY sub-channel A or PHY sub-channel B. This introduces sub channel level re-mapping between a memory controller and PHY circuitry. In examples, the MRC (which may be a part of BIOS) running on a processor core 150 may dynamically detect sub-channel mapping (and DQ lane mapping) between a memory controller and PHY circuitry based on the per-DQ lane Rx PLL delay margin test (e.g., based on a zero margin of the DQ lanes).

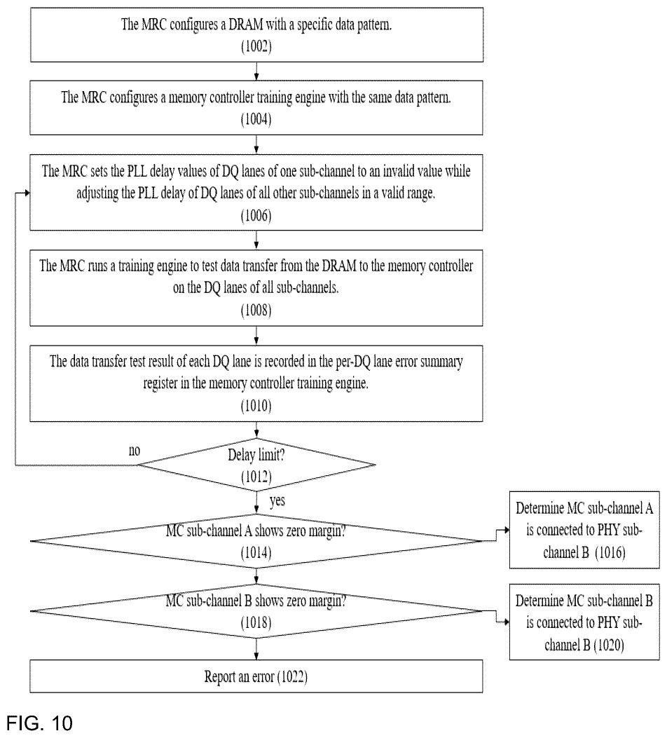

Examples for dynamically detecting sub-channel mapping between a memory controller and PHY circuitry will be explained hereafter. FIG. 10 is a flow diagram of an example process for dynamically detecting sub-channel mapping between a memory controller and PHY circuitry. In this example, it is assumed that memory controller sub-channel A is coupled to PHY sub-channel B and memory controller B is coupled to PHY sub-channel A as shown in FIG. 2. However, the examples are applicable to different configurations as well. Hereafter, the examples will be explained with the case where the Rx PLL delay of PHY sub-channel B is set to an invalid value while adjusting the PLL delay of PHY sub-channel A in a pre-configured range, but the data transfer test may be performed by setting the PLL delay of PHY sub-channel A to an invalid value while adjusting the PLL delay of PHY sub-channel B in a pre-configured range. It should be noted that that the examples are applicable to the case where the data lanes of the memory controller and the PHY circuitry are divided into more than two sub-channels, respectively. In such case, the data transfer test may be performed with an invalid Rx PLL delay value for one PHY sub-channel while adjusting the PLL delay of all other PHY sub-channels in a pre-configured range.

In some examples, the MRC running on a processor (i.e., a processor) configures a DRAM 140 with a specific data pattern for all sub-channels (1002). For example, the MRC may configure a DRAM mode register (e.g., mode register 26 and 27 (MR26, MR27)) with a specific data pattern so that the DRAM 140 can send out the specific data pattern to the memory controller 110 on each DQ lane of the sub-channels when the DRAM 140 receives a read command from the memory controller 110.

The MRC also configures the memory controller training engine 114 with the same data pattern as the DRAM 140 for all sub-channels (1004). The MRC configures the memory controller training engine 114 for reading data from the DRAM 140 and comparing it with the data pattern stored in the memory controller training engine 114.

The per-DQ lane Rx PLL delay margin test is then performed iteratively. The MRC sets the PLL delay values of DQ lanes of one sub-channel (e.g., sub-channel B) to an invalid value while adjusting/sweeping the PLL delay values of DQ lanes of all other sub-channels (e.g., sub-channel A) in a pre-configured range (1006). The invalid PLL delay value is a value that makes the data transfer on that data lane incorrect. For example, the MRC may initially set the PHY Rx PLL delay to a starting value (e.g., a minimum value) for DQ lanes of PHY sub-channel A and adjust step-by-step for each iteration, while keeping the PHY Rx PLL delay to an invalid value for DQ lanes of PHY sub-channel B. For each DQ lane on the PHY circuitry, there is a sideband control register 122. The MRC may configure the sideband control register 122 in the PHY circuitry 120 to set/adjust the Rx PLL delay for each DQ lane.

At each Rx PLL delay point, the MRC runs the training engine 114 to test the data transfer from the DRAM 140 to the memory controller 110 on the DQ lanes (1008). The training engine 114 sends out a read command to the DRAM 140 to read the pre-programmed specific data pattern from the DRAM 140 and compares the received data pattern with the same pre-programmed specific data pattern stored in the training engine 114.

The comparison result (pass/fail result) of each DQ lane is recorded in the per-DQ lane error summary register 418 in the memory controller training engine 114 (1010). A DQ lane can only transfer data correctly when the Rx PLL delay for the DQ lane is in a valid range. Therefore, the data transfer via the sub-channel whose PLL delay is set to an invalid value would fail. For example, if the PLL delay for the DQ lanes of sub-channel B is set to an invalid value, the data transfer via sub-channel B would fail and the delay margin of DQ lanes of sub-channel B would be zero.

It is then determined whether the pre-defined PHY Rx PLL delay (maximum) limit is reached (1012). If the pre-defined PHY Rx PLL delay limit is not reached, the process goes back to step 1006 for the next PHY Rx PLL delay. The MRC adjusts the PHY Rx PLL delay value step by step (e.g., from the pre-defined minimum limit to a pre-defined maximum limit) for sub-channel A in this example while keeping the PLL delay for sub-channel B invalid and iteratively performs the data transfer test at each PLL delay point.

If it is determined that the pre-defined PHY Rx PLL delay limit is reached (e.g., the PLL delay sweeping is done), the MRC determines sub-channel mapping between the memory controller and the PHY circuitry based on the data transfer test results (e.g., based on a map of pass/fail). The MRC may determine the sub-channel mapping based on the per-DQ lane Rx PLL delay margin test result. For example, the MRC may check the delay margin of the memory controller sub-channel A and B. If the memory controller sub-channel A shows a zero margin (1014), the MRC may determine that the memory controller sub-channel A is connected/mapped to PHY sub-channel B (1016). If the memory controller sub-channel B shows a zero margin (1018), the MRC may determine that the memory controller sub-channel B is connected/mapped to PHY sub-channel B (1020). If none of the sub-channels shows a zero margin, an error may be reported (1022).

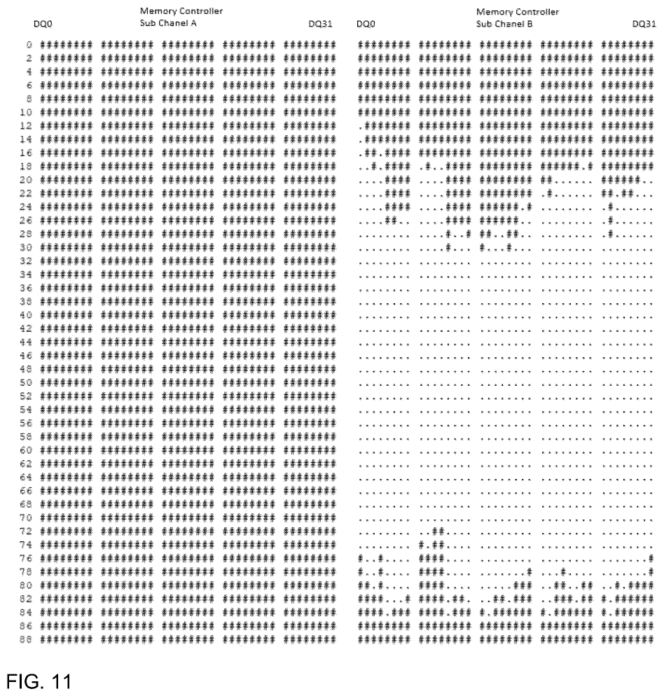

FIG. 11 shows an example data transfer pass/fail map. FIG. 11 shows an example test result (data transfer result) of each DQ lane viewed from a memory controller training engine side while the PLL delay value for sub-channel B in the PHY circuitry is held invalid while adjusting/sweeping the PLL delay of sub-channel A in the PHY circuitry in a pre-configured range. In FIG. 11, the x-axis is the DQ lane number (from DQO to DQ31) of sub-channels A and B of the memory controller, and the y-axis is the PHY Rx PLL delay values. If the data transfer is correct at a PLL delay point, the MRC prints ‘.’ for that DQ lane, which represents a “pass,” and if the data transfer is not correct at a PLL delay point, the MRC prints ‘#’ for that DQ lane, which represents a “failure.” In this example, since memory controller sub-channel A is connected to PHY sub-channel B and memory controller sub-channel B is connected to PHY sub-channel A as shown in FIG. 2 and the PLL delay for DQ lanes of PHY sub-channel B is held invalid, the DQ lanes of sub-channel A in the memory controller show a zero margin. In this example, from this test results, MRC can determine that memory controller sub-channel A is connected to PHY sub-channel B and memory controller sub-channel B is connected to PHY sub-channel A.

Examples for dynamically detecting DQ lane mapping between a memory controller and PHY circuitry based on data transfer test (by leveraging zero margin detection) will be explained hereafter. The DQ lane mapping between the memory controller and the PHY circuitry may be determined within a sub-channel if the data lanes are sub-divided into sub-channels. Alternatively, the DQ lane mapping may be performed independently of sub-channels.

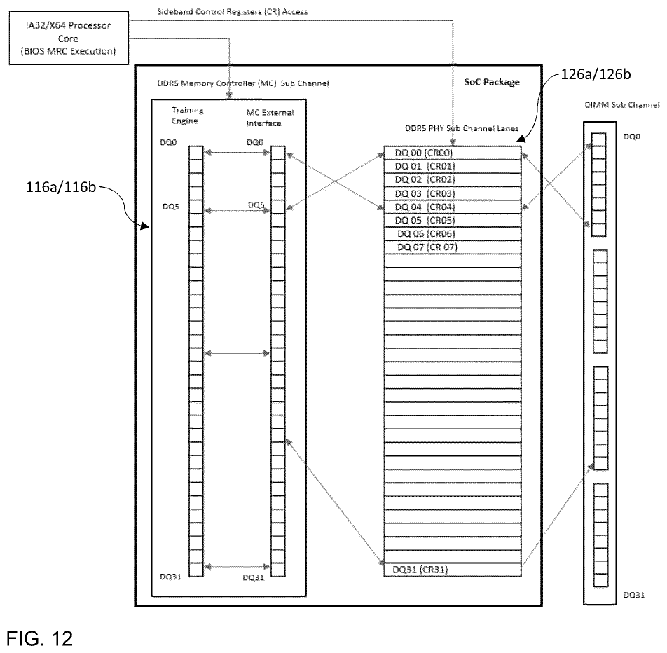

FIG. 12 shows an example DQ lane mapping within a sub-channel between a memory controller and PHY circuitry. Each DQ lane in a sub-channel 116a/116b of the memory controller 110 is mapped to one of DQ lanes of the mapped sub-channel 126a/126b of the PHY circuitry 120. As an example, FIG. 12 shows that DQO in the memory controller is mapped to DQ4 in the PHY circuitry, and DQ5 in the memory controller is mapped to DQO in the PHY circuitry. It should be noted that this data lane connection is merely an example, and the data lane mapping between the memory controller and the PHY circuitry can be different.

In examples, the MRC is modified to perform the per-DQ lane Rx PLL delay margin test to dynamically detect the DQ lane mapping (within a sub-channel or regardless of sub-channel) between the memory controller 110 and the PHY circuitry 120. In examples, the MRC may run the PLL delay margin test from the memory controller side while configuring an invalid Rx PLL delay value for a target DQ lane in the PHY circuitry 120 and adjusting/sweeping the Rx PLL delay of all other DQ lanes in the PHY circuitry 120 in a pre-configured range. Since the Rx PLL delay of one DQ lane (the target DQ lane) is kept invalid, this DQ lane cannot correctly transfer data and will lead to a zero margin on the corresponding DQ lane of the memory controller 110 coupled to the target DQ lane in the PHY circuitry 120.

The MRC determines which DQ lane of the PHY circuitry 120 is connected to which DQ lane of the memory controller 110 based on the data transfer test results. In examples, the MRC runs a PLL delay margin test on the memory controller side as described above. When performing the margin test, on the PHY circuitry side, the MRC keeps the Rx PLL delay of one DQ lane (a target DQ lane) in an invalid value while adjusting/sweeping the Rx PLL delay for all other DQ lanes in a pre-configured range. Since the PHY Rx PLL delay of the target DQ lane is invalid, the target DQ lane cannot correctly transfer data and will lead to a zero margin on the coupled DQ lane in the memory controller. This zero-margin test result will be reported by the memory controller training engine and the DQ lane mapping for the target DQ lane may be determined based on the zero margin test result. The test may be repeatedly performed for all DQ lanes (of the sub-channel or PHY circuitry), and the DQ lane mapping for all DQ lanes may be detected based on the zero margin test results.

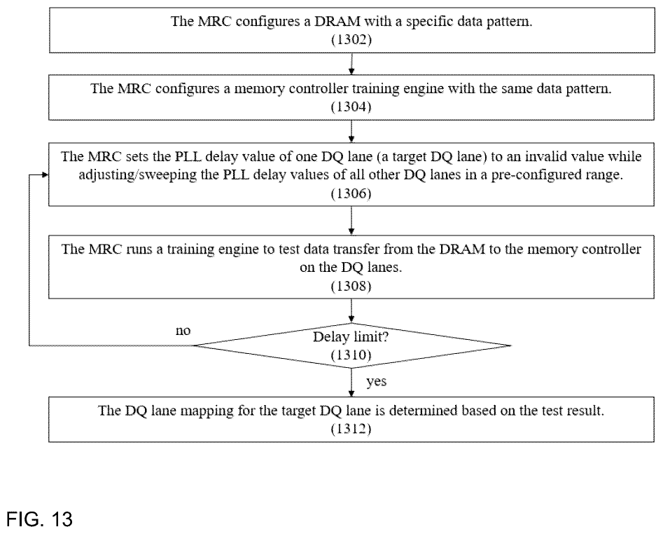

FIG. 13 is a flow diagram of an example process for detecting DQ lane mapping between a memory controller and PHY circuitry. The DQ lane mapping may be performed within a sub-channel. The MRC running on a processor configures a DRAM 140 with a specific data pattern (1302). The MRC may configure a DRAM mode register (e.g., mode register 26 and 27 (MR26, MR27)) with a specific data pattern so that the DRAM 140 can send out the specific data pattern to the memory controller 110 on each DQ lane when the DRAM 140 receives a read command from the memory controller 110.

The MRC also configures the memory controller training engine 114 with the same data pattern as the DRAM 140 (1304). The MRC configures the memory controller training engine 114 for reading data from the DRAM 140 and comparing it with the data pattern stored in the memory controller training engine 114.

The per-DQ lane Rx PLL delay margin test is then performed iteratively. The MRC sets the PLL delay value of one DQ lane (a target DQ lane) to an invalid value while adjusting/sweeping the PLL delay values of all other DQ lanes in a pre-configured range (1306). For example, the MRC may initially set the PHY Rx PLL delay to a starting value (e.g., a minimum value) for all other DQ lanes of the PHY circuitry 120 and adjust step-by-step for each iteration, while keeping the PHY Rx PLL delay to an invalid value for the target DQ lane of the PHY circuitry 120. For each DQ lane on the PHY circuitry, there is a sideband control register 122. The MRC configures the sideband control register 122 in the PHY circuitry 120 to set/adjust the Rx PLL delay for each DQ lane.

At each Rx PLL delay point, the MRC runs the training engine 114 to test the data transfer from the DRAM 140 to the memory controller 110 on the DQ lanes (1308). The training engine 114 sends out a read command to the DRAM 140 to read the pre-programmed data pattern from the DRAM 140 and compares the received data pattern with the same pre-programmed data pattern stored in the training engine 114.

It is then determined whether the pre-defined PHY Rx PLL delay (maximum) limit is reached (1310). If the pre-defined PHY Rx PLL delay limit is not reached, the process goes back to step 1306 for the next PHY Rx PLL delay. The MRC adjusts the PHY Rx PLL delay value for all other DQ lanes step by step (e.g., from the pre-defined minimum limit to a pre-defined maximum limit) while keeping the PLL delay for the target DQ lane invalid and iteratively performs the data transfer test at each PLL delay point.

If it is determined that the pre-defined PHY Rx PLL delay limit is reached (e.g., the PLL delay sweeping is done), the DQ lane mapping for the target DQ lane is determined based on the test result (the pass/fail result for the DQ lanes) (1312). A DQ lane in the PHY circuitry 120 can only transfer data correctly when the Rx PLL delay for the DQ lane is in a valid range. Therefore, the data transfer on the target DQ lane whose PLL delay is set to an invalid value would fail and the delay margin of the target DQ lane would be zero. The DQ lane mapping for the target DQ lane may be determined based on the zero delay margin. The MRC iteratively performs the process for all DQ lanes.

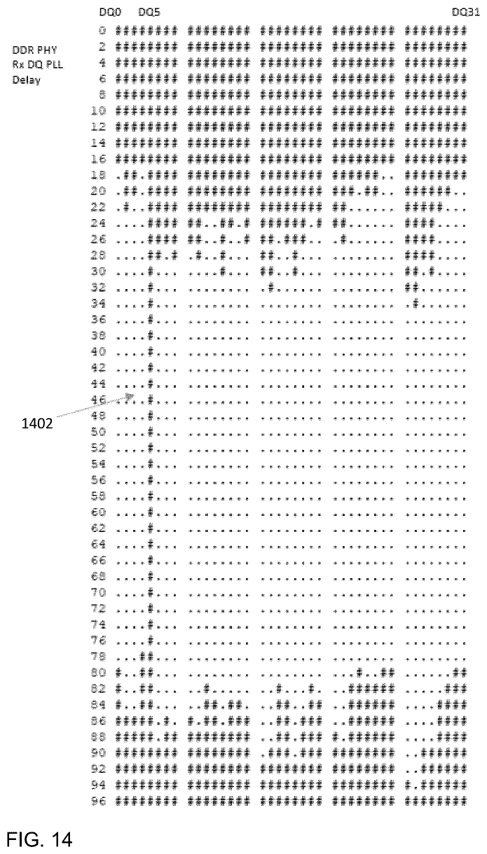

FIG. 14 shows an example test result (data transfer result) of the DQ lanes viewed from a memory controller training engine side. FIG. 14 shows the test result when the PLL delay value for DQO in the PHY circuitry is held invalid while adjusting/sweeping the PLL delay of all other DQ lanes in the PHY circuitry in a pre-configured range. In FIG. 14, the x-axis is the DQ lane number (from DQO to DQ31) of a sub-channel of the memory controller, and the y-axis is the PHY Rx PLL delay values. ‘.’ for a DQ lane represents a “pass,” and ‘#’ for a DQ lane represents a “failure.” In this example, since DQ5 of the memory controller 110 is connected to DQO of the PHY circuitry as shown in FIG. 12, when the PLL delay for DQO of the PHY circuitry 120 is held invalid, DQ5 of the memory controller 110 shows a zero delay margin (indicated by arrow 1402). From this test results, the MRC can determine that DQ5 of the memory controller 110 is connected to DQO of the PHY circuitry 120. The MRC can repeat the same procedure to determine other DQ lane's mapping in the same way.

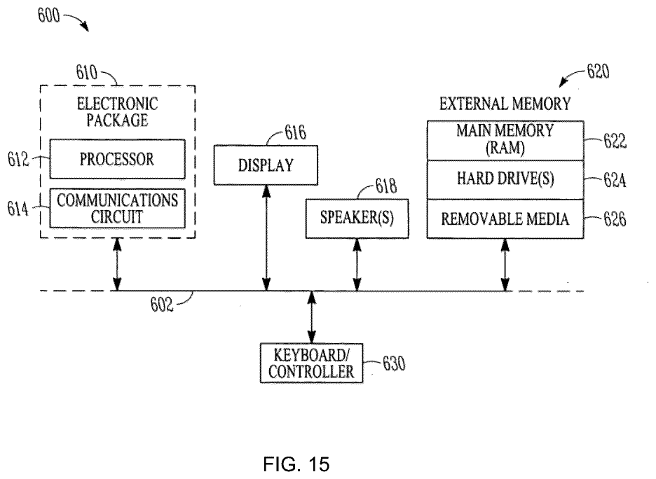

FIG. 15 is a block diagram of an electronic apparatus 600 incorporating at least one electronic assembly and/or method described herein. Electronic apparatus 600 is merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610 as describe herein may be coupled to system bus 602. The electronic assembly 610 may include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASlC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), flash memory cards, digital video disk (DVD), and the like.

The electronic apparatus 600 may also include a display device 616, one or more speakers 618, and a keyboard and/or controller 630, which can include a mouse, trackball, touch screen, voice—recognition device, or any other device that permits a system user to input information into and receive information from the electronic apparatus 600.

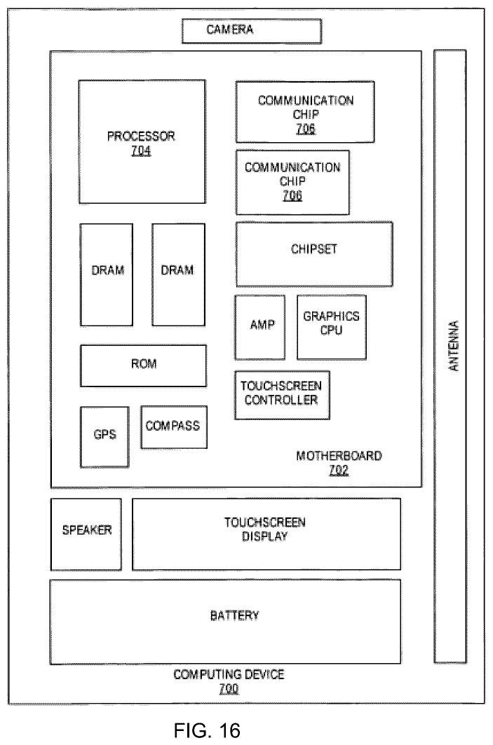

FIG. 16 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others. The processor 704 of the computing device 700 includes an integrated circuit die packaged within the processor 704. In some implementations of the invention, the integrated circuit die of the processor includes one or more devices that are assembled in an ePLB or eWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB or eWLB based POP package that that includes a mold layer directly contacting a substrate, in accordance with implementations of the invention.

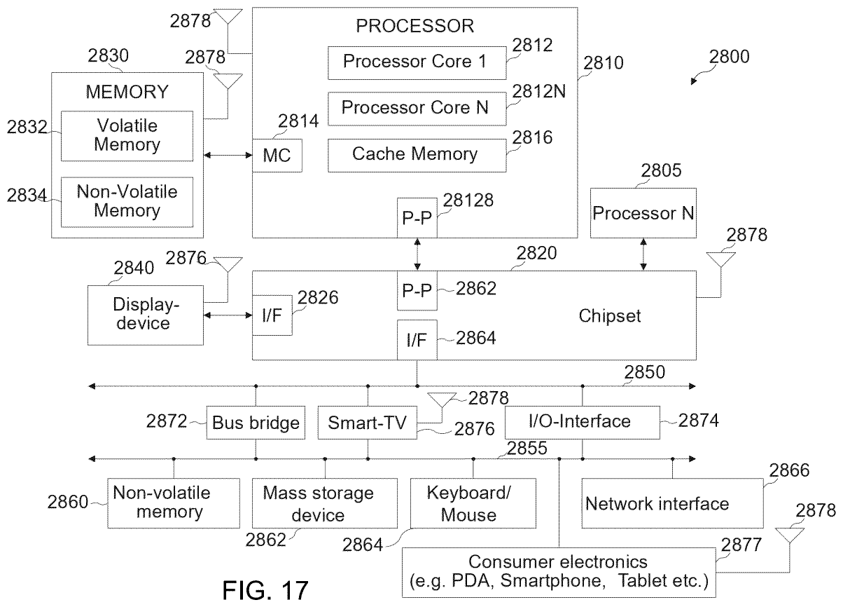

FIG. 17 is included to show an example of a higher-level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server. In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smart phone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 that includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using a MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the Intel® QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, cathode ray tube (CRT) display, or any other form of visual display device. In and embodiment, the processor 2810 and the chipset 2820 are merged into a MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 8 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to a method for detecting data lane mapping between a first circuitry and a second circuitry in a system. The first circuitry includes a plurality of first data lanes and the second circuitry includes a plurality of second data lanes and each first data lane is mapped to a different second data lane, and the second circuitry is configured to transfer data between the first circuitry and an external device via the plurality of second data lanes. The method may include configuring both the external device and the first circuitry with a specific data pattern, configuring the second circuitry for transfer of the specific data pattern from the external device to the first circuitry, performing a data transfer test, wherein the specific data pattern stored in the external device is transferred from the external device to the first circuitry via the plurality of second data lanes during the data transfer test, wherein the data transfer test is performed iteratively by adjusting timing parameters for the second data lanes in the second circuitry in a pre-configured range while setting a timing parameter for a target second data lane in the second circuitry to an invalid value, and determining data lane mapping for the target second data lane between the first circuitry and the second circuitry based on results of the data transfer test.

Another example, (e.g., example 2) relates to a previously described example (e.g., example 1), wherein the timing parameters are PLL delay values for the second data lanes in the second circuitry.

Another example, (e.g., example 3) relates to a previously described example (e.g., any one of examples 1-2), wherein the second circuitry includes control registers and the timing parameters for the second data lanes are controlled by using the control registers.

Another example, (e.g., example 4) relates to a previously described example (e.g., any one of examples 1-3), wherein the first data lanes and the second data lanes are divided into two or more sub-channels, and the timing parameter of second data lanes of one sub-channel is set to the invalid value and the timing parameters for the second data lanes of all other sub-channels in the second circuitry are adjusted in the pre-configured range, such that a sub-channel mapping between the first circuitry and the second circuitry is determined based on the results of the data transfer test.

Another example, (e.g., example 5) relates to a previously described example (e.g., any one of examples 1-4), wherein the determination of the data lane mapping between the first circuitry and the second circuitry is performed during a boot up of the system.

Another example, (e.g., example 6) relates to a previously described example (e.g., any one of examples 1-5), wherein the data transfer test is performed by sending a request to the external device, receiving the specific data pattern sent from the external device on the first data lanes, comparing the specific data pattern received from the external device to the specific data pattern stored in the first circuitry, and recording a comparison result for each first data lane in a register.

Another example, (e.g., example 7) relates to a previously described example (e.g., any one of examples 1-6), wherein the first circuitry is a memory controller of a memory sub-system, and the second circuitry is PHY circuitry of the memory sub-system.

Another example, (e.g., example 8) relates to a previously described example (e.g., example 7), wherein the memory controller and the PHY circuitry are integrated into a SoC.

Another example, (e.g., example 9) relates to a previously described example (e.g., any one of examples 7-8), wherein the method is implemented by BIOS MRC.

Another example, (e.g., example 10) relates to a previously described example (e.g., any one of examples 7-9), wherein the memory controller and the PHY circuitry are compliant to DDR5 standards.

Another example, (e.g., example 11) relates to a processor for detecting data lane mapping between a first circuitry and a second circuitry in a system. The first circuitry includes a plurality of first data lanes and the second circuitry includes a plurality of second data lanes and each first data lane is mapped to a different second data lane. The second circuitry is configured to transfer data between the first circuitry and an external device via the plurality of second data lanes. The processor may include processing circuitry configured to execute software code, wherein the software code is adapted, if executed on the processing circuitry, to configure both the external device and the first circuitry with a specific data pattern, configure the second circuitry for transfer of the specific data pattern from the external device to the first circuitry, perform a data transfer test, wherein the specific data pattern stored in the external device is transferred from the external device to the first circuitry via the plurality of second data lanes during the data transfer test, wherein the software code is adapted to perform the data transfer test iteratively by adjusting timing parameters for the second data lanes in the second circuitry in a pre-configured range while setting a timing parameter for a target second data lane in the second circuitry to an invalid value, and determine data lane mapping for the target second data lane between the first circuitry and the second circuitry based on results of the data transfer test.

Another example, (e.g., example 12) relates to a previously described example (e.g., example 11), wherein the timing parameters are PLL delay values for the second data lanes in the second circuitry.

Another example, (e.g., example 13) relates to a previously described example (e.g., any one of examples 11-12), wherein the second circuitry includes control registers and the timing parameters for the second data lanes are controlled by using the control registers.

Another example, (e.g., example 14) relates to a previously described example (e.g., any one of examples 11-13), wherein the first data lanes and the second data lanes are divided into two or more sub-channels, and the timing parameter of second data lanes of one sub-channel is set to the invalid value and the timing parameter of second data lanes of all other sub-channels is adjusted in the pre-configured range such that a sub-channel mapping between the first circuitry and the second circuitry is determined based on the results of the data transfer test.

Another example, (e.g., example 15) relates to a previously described example (e.g., any one of examples 11-14), wherein the determination of the data lane mapping between the first circuitry and the second circuitry is performed during a boot up of the system.

Another example, (e.g., example 16) relates to a system on chip (SoC) comprising a processor configured to execute MRC, a memory controller including a plurality of first data lanes, and a PHY circuitry including a plurality of second data lanes. Each first data lane in the memory controller is mapped to a different second data lane in the PHY circuitry and the PHY circuitry is configured to transfer data between the memory controller and a memory module via the plurality of second data lanes. The MRC is configured, if executed on the processor, to perform the method as in any one of examples 1-10.

Another example, (e.g., example 17) relates to a previously described example (e.g., example 16), wherein the memory controller and the PHY circuitry are compliant to DDR5 standards.

Another example, (e.g., example 18) relates to a previously described example (e.g., any one of examples 16-17), wherein the first data lanes and the second data lanes are divided into two or more sub-channels, and the MRC is configured to determine a sub-channel mapping between the first circuitry and the second circuitry is determined based on the results of the data transfer test.

Another example, (e.g., example 19) relates to a previously described example (e.g., any one of examples 16-18), wherein the MRC is configured to adjust PLL delay values for the second data lanes in the second circuitry to perform the data transfer test.

Another example, (e.g., example 20) relates to a non-transitory machine-readable medium including code, when executed, to cause a machine to perform the method as in any one of examples 1-10.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or—steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A method for detecting data lane mapping between a first circuitry and a second circuitry in a system, wherein the first circuitry includes a plurality of first data lanes and the second circuitry includes a plurality of second data lanes and each first data lane is mapped to a different second data lane, and the second circuitry is configured to transfer data between the first circuitry and an external device via the plurality of second data lanes, the method comprising:
configuring both the external device and the first circuitry with a specific data pattern;
configuring the second circuitry for transfer of the specific data pattern from the external device to the first circuitry;
performing a data transfer test, wherein the specific data pattern stored in the external device is transferred from the external device to the first circuitry via the plurality of second data lanes during the data transfer test, wherein the data transfer test is performed iteratively by adjusting timing parameters for the second data lanes in the second circuitry in a pre-configured range while setting a timing parameter for a target second data lane in the second circuitry to an invalid value; and
determining data lane mapping for the target second data lane between the first circuitry and the second circuitry based on results of the data transfer test.

2. The method of claim 1, wherein the timing parameters are phase-locked loop (PLL) delay values for the second data lanes in the second circuitry.

3. The method of claim 1, wherein the second circuitry includes control registers and the timing parameters for the second data lanes are controlled by using the control registers.

4. The method of claim 1, wherein the first data lanes and the second data lanes are divided into two or more sub-channels, and the timing parameter of second data lanes of one sub-channel is set to the invalid value and the timing parameters for the second data lanes of all other sub-channels in the second circuitry are adjusted in the pre-configured range, such that a sub-channel mapping between the first circuitry and the second circuitry is determined based on the results of the data transfer test.

5. The method of claim 1, wherein the determination of the data lane mapping between the first circuitry and the second circuitry is performed during a boot up of the system.

6. The method of claim 1, wherein the data transfer test is performed by:
sending a request to the external device;
receiving the specific data pattern sent from the external device on the first data lanes;
comparing the specific data pattern received from the external device to the specific data pattern stored in the first circuitry; and
recording a comparison result for each first data lane in a register.

7. The method of claim 1, wherein the first circuitry is a memory controller of a memory sub-system, and the second circuitry is physical layer (PHY) circuitry of the memory sub-system.

8. The method of claim 7, wherein the memory controller and the PHY circuitry are integrated into a system on chip (SoC).

9. The method of claim 7, wherein the method is implemented by basic input/output system (BIOS) memory reference code (MRC).

10. The method of claim 7, wherein the memory controller and the PHY circuitry are compliant to Fifth Generation Double Data Rate (DDR5) standards.

11. A processor for detecting data lane mapping between a first circuitry and a second circuitry in a system, wherein the first circuitry includes a plurality of first data lanes and the second circuitry includes a plurality of second data lanes and each first data lane is mapped to a different second data lane, and the second circuitry is configured to transfer data between the first circuitry and an external device via the plurality of second data lanes, the processor comprising:
processing circuitry configured to execute software code, wherein the software code is adapted, if executed on the processing circuitry, to:
configure both the external device and the first circuitry with a specific data pattern;
configure the second circuitry for transfer of the specific data pattern from the external device to the first circuitry;
perform a data transfer test, wherein the specific data pattern stored in the external device is transferred from the external device to the first circuitry via the plurality of second data lanes during the data transfer test, wherein the software code is adapted to perform the data transfer test iteratively by adjusting timing parameters for the second data lanes in the second circuitry in a pre-configured range while setting a timing parameter for a target second data lane in the second circuitry to an invalid value; and
determine data lane mapping for the target second data lane between the first circuitry and the second circuitry based on results of the data transfer test.

12. The processor of claim 11, wherein the timing parameters are phase-locked loop (PLL) delay values for the second data lanes in the second circuitry.

13. The processor of claim 11, wherein the second circuitry includes control registers and the timing parameters for the second data lanes are controlled by using the control registers.

14. The processor of claim 11, wherein the first data lanes and the second data lanes are divided into two or more sub-channels, and the timing parameter of second data lanes of one sub-channel is set to the invalid value and the timing parameter of second data lanes of all other sub-channels is adjusted in the pre-configured range such that a sub-channel mapping between the first circuitry and the second circuitry is determined based on the results of the data transfer test.

15. The processor of claim 11, wherein the determination of the data lane mapping between the first circuitry and the second circuitry is performed during a boot up of the system.

16. A system on chip (SoC) comprising:
a processor configured to execute memory reference code (MRC);
a memory controller including a plurality of first data lanes; and
a physical layer (PHY) circuitry including a plurality of second data lanes, wherein each first data lane in the memory controller is mapped to a different second data lane in the PHY circuitry and the PHY circuitry is configured to transfer data between the memory controller and a memory module via the plurality of second data lanes,
wherein the MRC is configured, if executed on the processor, to perform the method of claim 1.

17. The SoC of claim 16, wherein the memory controller and the PHY circuitry are compliant to Fifth Generation Double Data Rate (DDR5) standards.

18. The SoC of claim 16, wherein the first data lanes and the second data lanes are divided into two or more sub-channels, and the MRC is configured to determine a sub-channel mapping between the first circuitry and the second circuitry is determined based on the results of the data transfer test.

19. The SoC of claim 16, wherein the MRC is configured to adjust phase-locked loop (PLL) delay values for the second data lanes in the second circuitry to perform the data transfer test.

20. A non-transitory machine-readable medium including code, when executed, to cause a machine to perform the method of claim 1.
